(19) United States
(12) Patent Application Publication
(10) Pub. No.: US 2022/0018557 A1
(43) Pub. Date: Jan. 20, 2022

(54) AIR PURIFYING UNIT, AIR PURIFYING DEVICE AND AIR PURIFYING ASSEMBLY

(71) Applicant: RENAUD GREEN TECHNOLOGY LIMITED, Kowloon (HK)

(72) Inventor: Tak Wing Wong, Tsuen Wan, New Territories (HK)

(21) Appl. No.: 17/294,110

(22) PCT Filed: Nov. 28, 2019
(86) PCT No.: PCT/CN2019/121619

§ 371 Date: May 14, 2021

(30) Foreign Application Priority Data
Dec. 4, 2018 (CN) 201822025029.1

(51) Int. Cl. F24F 8/175; F24F 3/16; A01G 9/24; A01G 27/00

(52) U.S. Cl. CPC F24F 8/175; F24F 3/16; A01G 27/003; A01G 9/246; A01G 9/249; A01G 9/247

(57) ABSTRACT

An air purifying unit (52) includes a soil container (8) containing soil (5), an air flow generator (3) for drawing air from outside of the air purifying unit (52), through the soil (5) in the soil container (8), and out of the air purifying unit (52), and an automatic nutrient delivery system for delivering a nutrient to the soil (5).

This invention relates to an air purifying unit, an air purifying device incorporating at least one such air purifying unit, and an air purifying assembly.

### BACKGROUND OF THE INVENTION

Nowadays, in most countries around the world, the quality of indoor and outdoor air is far from satisfactory. The problem is more acute in developing industrial countries. Hundreds of pollutants and poisonous materials in the air are hampering the health of human beings.

The deterioration of outdoor air quality is due partly to electricity plants generating electricity by burning fossil fuels (e.g. coal), and emissions from industrial plants, factories and automobiles. All these result in the existence of a high level of carbon dioxide (CO₂), carbon monoxide (CO), nitrogen oxides (NO_{X}), dust and smoke, particulate materials (PM) 2.5, total volatile organic compounds (TVOCs), which negatively affect the health of human beings.

Air from the outside environment carrying various poisonous materials enters residential flats, offices, hotels and shopping malls, through windows and ventilating systems, thus mixing with all kinds of bacteria, germs and organic compounds indoor, such that the amount and concentration of poisonous materials indoor may even be more than those of the air outdoor. In addition, furniture in the living environment continuously releases all kinds of poisonous chemical compounds.

There have been provided various indoor air purifying devices in the hope of addressing such problems. Such existing air purifying devices usually adopt one of the following technologies: (a) filter mesh/membrane, (b) activated carbon, (c) static electricity, (d) artificial negative ions, (e) photo-catalysts, (f) titanium dioxide coating, and (g) ozone.

On the other hand, there is not in the market an air purifying device which can kill germs and harmful bacteria, and can eliminate the poisonous gases without transferring them elsewhere. Neither is there any existing air purifying device that can purify air both indoor and outdoor.

It is thus an object of the present invention to provide an air purifying unit, an air purifying device incorporating at least one such air purifying unit, and an air purifying assembly in which the aforesaid shortcomings are mitigated or at least to provide a useful alternative to the trade and public.

### SUMMARY OF THE INVENTION

According to a first aspect of the present invention, there is provided an air purifying unit including a soil container containing soil, an airflow generator for drawing air from outside of said air purifying unit, through said soil in said soil container, and out of said air purifying unit, and an automatic nutrient delivery system for delivering a nutrient to said soil.

According to a second aspect of the present invention, there is provided an air purifying device including an air purifying unit including a soil container containing soil, an airflow generator for drawing air from outside of said air purifying unit, through said soil in said soil container, and out of said air purifying unit, and an automatic nutrient delivery system for delivering a nutrient to said soil, and at least one land plant planted in said soil in said soil container.

According to a third aspect of the present invention, there is provided an air purifying assembly including a plurality of soil containers containing soil, at least one automatic nutrient delivery system for delivering a nutrient to said soil, and at least one airflow generator for drawing air from outside of said air purifying assembly, through said soil in said plurality of soil containers, and out of said soil in said plurality of soil containers.

### BRIEF DESCRIPTION OF THE DRAWINGS

Embodiments of the present invention will now be described, by way of examples only, with reference to the accompanying drawings, in which:

FIG. 1 shows a vertical schematic sectional view of an air purifying device according to an embodiment of the present invention;

FIG. 2 shows a perspective schematic view of a soil container according to an embodiment of the present invention;

FIG. 3 shows a perspective schematic view of an air purifying assembly according to an embodiment of the present invention;

FIG. 4 shows a perspective schematic view of an air purifying assembly according to another embodiment of the present invention;

FIG. 5 shows a perspective schematic view of an air purifying assembly according to a further embodiment of the present invention;

FIG. 6 shows a sectional schematic view of the air purifying assembly of FIG. 5; and

FIG. 7 shows a schematic diagram of a controlling mechanism according to an embodiment of the present invention.

### DETAILED DESCRIPTION OF THE EMBODIMENTS

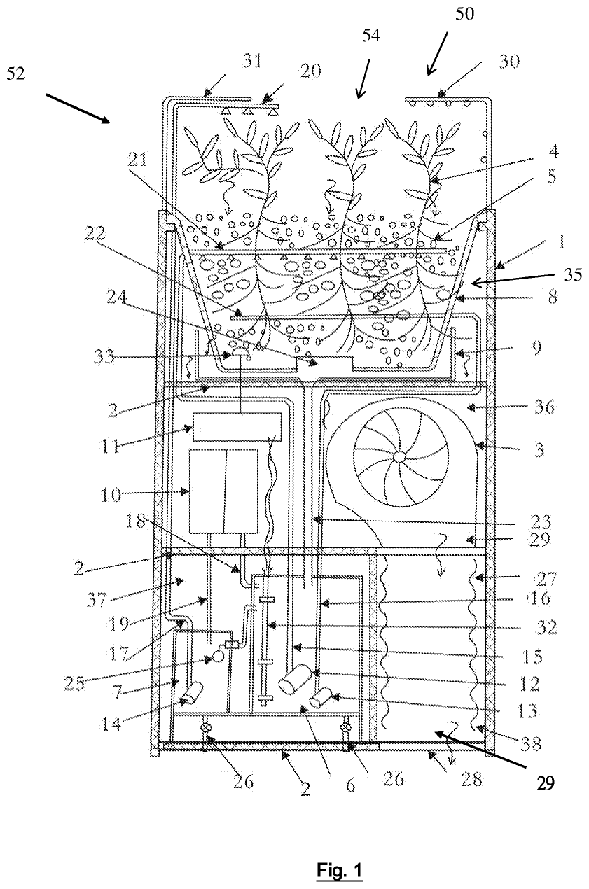

An electrically operated air purifying device according to an embodiment of the present invention is shown in FIG. 1, and generally designated as 50. The air purifying device 50 includes an air purifying unit according to the present invention generally designated as 52, with a plant 4 planted in it. The plant 4 may be a land plant (Embryophyte) which have roots and can be grown in artificial soil (to be discussed below), e.g. various kinds of seed plants and flowering plants. The air purifying device 50 may be powered by an AC power source and/or a DC power source.

As shown in FIG. 1, the air purifying device 50 has a housing 1 for housing various parts and components of the air purifying device 50, leaving an opening 54 at a top to allow exchange of air with the outside environment and entry of ambient light. Towards the upper part of the housing 1 of the air purifying device 50 is a plant chamber 35 housing a soil container 8. One or more ledges provided along an interior surface of the plant chamber 35 support an upper rim of the soil container 8.

Artificial soil 5 is contained within the soil container 8. The artificial soil 5 includes stones, porous stones, porous high-temperature calcined soil, porous fossils and shells with creeks or gaps. The artificial soil 5 has been pre-treated by being soaked in water with sugar and/or yeast-type fermenting preparations for about two (2) weeks to one (1) month. The plant 4 is planted in and supported by the artificial soil 5 for growth. The artificial soil 5 also provides the environment for the growth of micro-organisms, e.g. obligate aerobes and/or facultative anaerobes, which are conducive to the elimination and/or reduction of various pollutants and poisonous materials in the air.

At an upper inner wall of the housing 1 are installed a number of lighting devices (e.g., electric lighting devices such as LED lights 30) which regularly provide light to the plant 4. Light from the LED lights 30 allows the plant 4 to carry out photosynthesis continuously, if the plant 4 is a green plant which uses the energy of sunlight to synthesize its food from carbon dioxide and water. An advantage of providing light regularly to the plant 4 is that as a raw material for photosynthesis is carbon dioxide and a by-product of photosynthesis is oxygen, continuous photosynthesis by the plant 4 will increase the amount of oxygen in the surrounding air and simultaneously reduce the amount of carbon dioxide in the surrounding air. This is particularly advantageous at night time, when there is normally only a low level of ambient light. As the LED lights 30 are positioned within the housing 1 and their light is directed to the plant 4, operation of the LED lights 30 (even at night time) would cause minimal light interference to people living (e.g. sleeping) in the area (e.g. a room) in which the purifying device 50 is operated. As an alternative arrangement, the LED lights 30 may be positioned at or around the centre of the soil container 8, so that they are covered by the leaves of the plant 4.

The soil container 8 is made of an air-permeable material or has openings which allow air to pass through. At a bottom part of the soil container 8 is a water outlet 24 which allows liquid (water and/or nutrient solution) from within the soil container 8 to pass to a water container 9 below the soil container 8. The water container 9 sits on top of a first partition board 2 in the housing 1.

Below the first partition board 2 is a middle chamber 36 which houses an airflow generator, which may be an electric airflow generator in the form of an electric fan 3, an electronic controller 11, and an automatic nutrient supply container 10. The electronic controller 11 may be a 4G or 5G electronic controller for coordinating and managing the operation of various electrical and/or electronic components of the air purifying device 50 with which it is connected, including (but not limited to) a moisture sensor 33 for sensing the moisture level in the soil 5.

A second partition board 2 is positioned at the bottom of the middle chamber 36, and below the second partition board 2 are a container chamber 37 and an air channel 38 with an air outlet 28. The container chamber 37 and the air channel 38 are separated from each other. The air channel 38 is in an air communicable relationship with an outlet of the fan 3. The air channel 38 is surrounded by sound-absorbing fabric 27. By way of such an arrangement, the fan 3 is operable to draw air from outside of the air purifying device 50 to pass through, consecutively, the soil 5 in the soil container 8, the soil container 8, the fan 3, the air channel 38, and the air outlet 28, and thereby out of the air purifying device 50. The arrows designated by the reference numeral 29 in FIG. 1 show the direction of flow of air from the fan 3 through and eventually out of the air channel 38 through the air outlet 28.

By way of such an arrangement, air outside of the air purifying device 50 is drawn by the fan 3 to pass through the soil 5 in the soil container 8. The micro-organisms in the soil 5 assist in eliminating and/or reducing the pollutants and poisonous materials in the drawn-in air, e.g. by way of consuming, absorbing, adsorbing, decomposing, and/or degrading at least some of such pollutants and poisonous materials, whether chemically, biologically or otherwise. The air drawn into and subsequently discharged from the air purifying device 50 is thus purified.

The container chamber 37 houses a first tank 6 and a second tank 7. The first tank 6 is connected with the automatic nutrient supply container 10 through a tube 18, whereby nutrient contained in the automatic nutrient supply container 10 may be supplied to the first tank 6. The second tank 7 is connected with the automatic nutrient supply container 10 through a tube 19, whereby nutrient contained in the automatic nutrient supply container 10 may be supplied to the second tank 7. The water container 9 is fluidly connected with the first tank 6 through a tube 23, whereby liquid (e.g. water and nutrient solution) received by the water container 9 may fall to the first tank 6 for possible re-use.

The first tank 6 is connected with a first valved water outlet tube 26 which allows, if desired, the content in the first tank 6 to be discharged to the outside environment. Similarly, the second tank 7 is connected with a second valved water outlet tube 26 which allows, if desired, the content in the first tank 6 to be discharged to the outside environment. Both the first and second valved water outlet tubes 26 extend through a bottom partition board 2 of the housing 1.

The first tank 6 has a first electric pump 12 which is connected with a tube 15 for delivering the content in the first tank 6 to a number of discharge outlets arranged along a discharge line 21 which extends into the soil 5 for delivering the content in the first tank 6 into the soil 5 directly. The first tank 6 also has a second electric pump 13 which is connected with a tube 16 for delivering the content in the first tank 6 to a number of discharge outlets arranged along a discharge line 22 which extends into the soil 5 for delivering the content in the first tank 6 into the soil 5 directly. It can be seen that the outlets along the discharge line 21 are at a higher height within the soil 5 than the outlets along the discharge line 22. The first tank 6 also has a water-level switch 32 which is connected with and operated by the electronic controller 11.

The second tank 7 has an electric high pressure atomizer pump 14 which is connected with a tube 17 for delivering the content in the second tank 7 to a number of atomizers 20 adjacent and below a frame 31 of the housing 1, for delivering the content in the second tank 7 from above the soil 5, in particular from above the plant 4 supported by the soil container 8. The content of the second tank 7 may for example be delivered to the leaves of the plant 4. The second tank 7 is in a fluid communicable relationship with the first tank 6 via a liquid replenishment floating ball valve 25, which allows the content in the first tank 6 to be delivered to the second tank 7 when the liquid level in the second tank 7 falls to or below a pre-set level, for replenishing the content in the second tank 7. As an alternative arrangement, the atomizers 20 and the frame 31 are positioned at or around the centre of the soil container 8, so that they are covered by the leaves of the plant 4.

During operation, under the control of the electronic controller 11, nutrient (in liquid form or solid form, e.g. powder) conducive to the growth of the plant 4 contained in the automatic nutrient supply container 10 is automatically supplied to the first tank 6 and the second tank 7, via the tube 18 and the tube 19 respectively. Such automatic supply of the nutrient to the first tank 6 and the second tank 7 may he effected at pre-set time intervals, which may be the same or different for the first tank 6 and the second tank 7. The nutrient is made up of, amongst other ingredients, a Bacillus subtilis micro-organism preparation, minerals, composite vitamins, and amino acids.

The nutrient from the automatic nutrient supply container 10 supplied to the first tank 6 is mixed with water in the first tank 6 to form a nutrient-containing content (e.g. nutrient solution), which is then delivered (upon activation of the pumps 12, 13) directly into the soil 5. As one possible arrangement, the moisture sensor 33 connected with the controller 11 senses the moisture level in the soil 5 and if the moisture level in the soil 5 as sensed by the moisture sensor 33 is below a pre-set threshold level, the electronic controller 11 activates the pumps 12, 13 to automatically draw the nu it solution in the first tank 6 for direct delivery into the soil 5.

The high pressure atomizer pump 14 in the tank 7 may be pre-set to activate automatically at regular time intervals, so as to automatically regularly draw the nutrient-containing content in the second tank 7 (e.g. nutrient solution formed by the mixing of the nutrient from the automatic nutrient supply container 10 with water in the second tank 7) and deliver it to the soil 5 from above the soil 5, in particular from above the plant 4 supported by the soil container 8, e.g. onto the leaves of the plant 4.

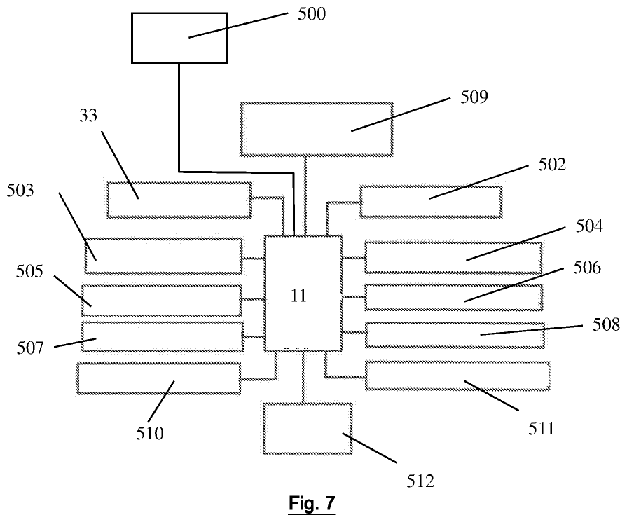

To enhance the functionality of the air purifying unit 52, and as shown in FIG. 7, the controller 11 (with a display), which may be a 4G or 5G Internet-of-Things (IoT) controller, is provided and connected with a PM 2.5 sensor 500 for sensing the amount of PM 2.5 in the surrounding environment. In addition, the controller 11 is functionally connected with (whether through wires or wirelessly), controls the operation of and receives feedback from the moisture sensor 33 for sensing the moisture level of the soil 5, a temperature sensors 502, a methanal sensor 503, a carbon dioxide sensor 504, a total volatile organic compounds (VTOCs) sensor 505, a sulfur dioxide sensor 506, a nitrogen dioxide sensor 507, a negative ion sensor 508, and a global positioning system (GPS) system component 512 for connection with a GPS system. The electronic controller 11 may also be connected with a light sensor (not shown) which senses the ambient light level. When the ambient light in the surrounding environment is above a certain pre-set level, the lighting devices 30 may be switched off. On the other hand, when the ambient light in the surrounding environment is below a certain pre-set level, the lighting devices 30 may be switched on. In addition, the electronic controller 11 may include a day time/night time circuit, such that when it is night time, it controls the lighting devices 30 to operate at an appropriate light level, so as not to interfere with the user's sleeping. The electronic controller 11 is also connected with, controls the operation of and receives feedback from a port/ports 509 connected with various electrical components (e.g. the fan 3, the lighting devices 30, and the various pumps 13, 14, 15), a user server port 510 for connection with a user server, and a user mobile device/computer operation interface 511. Such arrangement allows better operation of the air purifying unit 52. In particular, the user may remotely operate, control and monitor the air purifying unit 52.

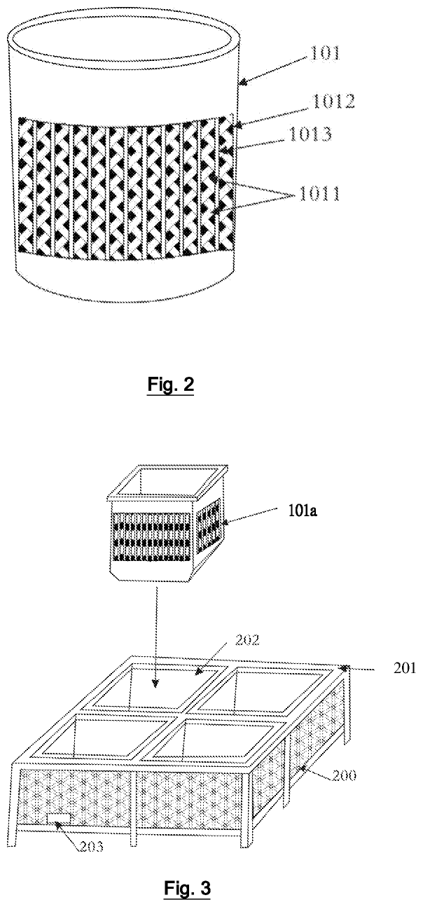

FIG. 2 shows a perspective view of a soil container according to an embodiment of the present invention, generally designated as 101. The soil container 101 is shown as being cylindrical in shape having a circular upper opening leading to a central cylindrical space for receiving soil (e.g. artificial soil 5). A side wall of the soil container 101 is provided with a number of stainless steel mesh cards with frames 1011. The mesh cards with frames 1011 include a number of eyelets 1012, 1013 which prevent passage of sand but allow water and air to pass through.

FIG. 3 shows a perspective view of a small-scale air purifying assembly 200 according to an embodiment of the present invention. The air purifying assembly 200 includes a number of soil containers 101a (of which only one is shown in FIG. 3) and an assembly framework 201. Apart from the fact that the soil container 101a is shown as being in the shape of a generally rectangular prism with a central rectangular space for receiving soil (e.g. artificial soil 5), its structure is otherwise the same as that of the soil container 101 shown in FIG. 2.

The assembly framework 201 may be made of various materials, such as metal, plastics, bamboo, wood, porcelain, terra cotta, concrete, brick, stone, or a combination of them, and includes a number of recesses 202 which are each shaped and configured to receive a respective of the soil container 101a. The assembly framework 201 is provided with an automatic nutrient delivery system for delivering a nutrient to the soil in the soil containers 101a, at least one airflow generator (e.g. an electric airflow generator in the form of an electric fan) for drawing air from outside of the air purifying assembly 200, through the soil in the soil containers 101a, and through the soil containers 101a, eventually to be discharged out of the air purifying assembly 200 to the outside environment through a common air outlet 203.

The specific arrangement of the automatic nutrient delivery system for delivering a nutrient to the soil in the soil containers 101a is similar to that as discussed in relation to the air purifying unit 52. Generally speaking, such an automatic nutrient delivery system includes a central electronic controller (e.g. 4G or 5G controller) for controlling, operating, monitoring and coordinating the operation of various electrical and/or electronic components (such as electric pumps, electric fan(s), PM 2.5 detector(s), temperature sensor(s), methanal sensor(s), carbon dioxide sensor(s), total volatile organic compounds (VTOCs) sensor(s), sulfur dioxide sensor(s), nitrogen dioxide sensor(s), negative ion sensor(s), and global positioning system (GPS) system component(s) for connection with a GPS system) whereby nutrient (usually in the form of a nutrient solution) is automatically delivered to the soil in the soil containers 101a, such as directly into the soil and/or from above the soil onto a land plant planted in the soil of each soil container 101a.

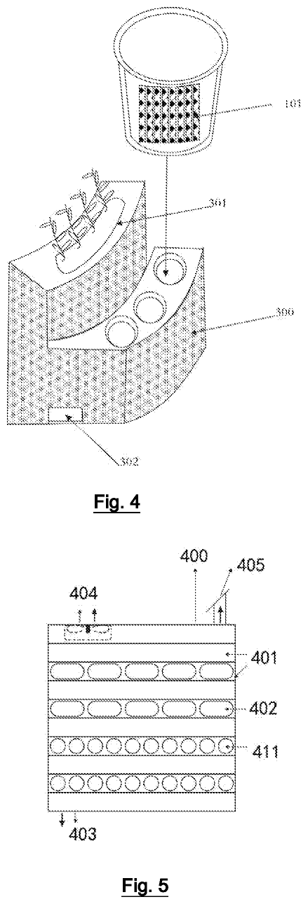

FIG. 4 shows a perspective view of a medium-scale multi-layered air purifying assembly 300 according to another embodiment of the present invention. The air purifying assembly 300 has two layers of recesses for receiving one or more soil containers 101. It can be seen that while the lower layer of the air purifying assembly 300 has three recesses, each for receiving a respective soil container 101, the upper layer includes an oblong recess for receiving a differently-shaped soil container 301 in which more plants may be planted. In other respects, the structure, construction and arrangement of the air purifying assembly 300 are similar to those of the air purifying assembly 200 discussed above. For example, there is also a common air discharge 302 allowing the discharge of air drawn from the outside environment, through the soil in the soil containers 101, 301 and through the soil containers 101, 301, to be discharged to the outside environment.

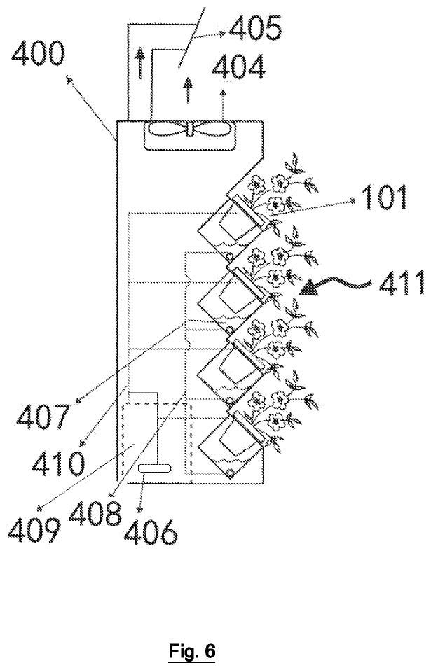

FIG. 5 shows a perspective view of a large-scale air purifying assembly 400 according to a further embodiment of the present invention, and FIG. 6 shows a sectional view of the air purifying assembly 400 installed with soil containers with plants. The air purifying assembly 400 has a housing with supports 401 having oblong recesses 402 and circular recesses each for receiving one or more soil containers, such as soil containers with an oblong cross-section or soil containers 101 with a circular cross-section. An airflow generator, such as an electric fan, is provided at an upper end of the housing 401 for drawing air from outside of the air purifying assembly 400, through soil contained in the various soil containers (including soil containers 101), through the soil containers (including soil containers 101), and eventually out of the air purifying assembly 400 to the outside environment through air outlets 403, 405. In particular, the air from outside of the air purifying assembly 400 enters the soil in the soil containers in the direction indicated by the arrow with reference numeral 411.

The air purifying assembly 400 has an automatic nutrient delivery system for delivering a nutrient to the soil. As shown in more detail in FIG. 6, a tank 409 is within the housing 401, and an electric pump 406 is positioned within the tank 409. The tank 409 is for receiving a nutrient-carrying liquid, e.g. a nutrient solution. The electric pump 406 is pre-set to draw, at a pre-determined time-pattern, the nutrient solution from within the tank 409 to the soil in the soil containers 101 through a number of delivery tubes 410 which are arranged in parallel with each other. Water and/or nutrient solution not readily retained in the soil of the soil containers 101 may exit the soil containers 101 and be collected by a number of water containers 407 each below a respective of the soil containers 101, tor subsequent return to the tank 409 through a return tube 408. Upon operation, an electric fan 404 at the top end of the assembly 400 is activated to draw air from outside of the assembly 400 to enter the soil in the soil containers 101 (in the direction indicated by the arrows with reference numeral 411), then through the soil, through the soil containers 101, and eventually exit the assembly 400 via an outlet 405.

By way of the above arrangements, the air in the surrounding environment of the air purifying units 52, air purifying devices 50 and air purifying assemblies 200, 300, 400 according to the present invention may be purified. Some of the pollutants and poisonous materials which may be blocked, consumed, absorbed, adsorbed, decomposed, and/or degraded by the air purifying units 52, air purifying devices 50 and air purifying assemblies 200, 300, 400 according to the present invention include methanal (formaldehyde) (CH₂O), TVOCs, PM 2.5, sulfur dioxide (SO₂), nitrogen dioxide (NO₂), ammonia (NH₃), and radon (Rn). The plants 4 also assist in enhancing the quality of the air in the surrounding environment by net emission of oxygen and negative ions.

It should be understood that the above only illustrates examples whereby the present invention may be carried out, and that various modifications and/or alterations may be made thereto. It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. An air purifying unit (52) including: a soil container (8) containing soil (5), an airflow generator (3) for drawing air from outside of said air purifying unit, through said soil in said soil container, and out of said air purifying unit, and an automatic nutrient delivery system for delivering a nutrient to said soil.

2. The air purifying unit according to claim 1, wherein said automatic nutrient delivery system includes a first nutrient delivery mechanism for delivering said nutrient directly into said soil and a second nutrient delivery mechanism for delivering said nutrient from above said soil onto a land plant (4) planted in said soil.

3. The air purifying unit according to claim 2, wherein said first nutrient delivery mechanism includes at least a nutrient outlet within said soil.

4. The air purifying unit according to claim 2, wherein said first nutrient delivery mechanism includes at least two nutrient outlets each at a different height within said soil.

5. The air purifying unit according to claim 2, further including a moisture sensor (33) for sensing the moisture level in said soil, wherein said first nutrient delivery mechanism is adapted to deliver said nutrient directly into said soil when the moisture level in said soil as sensed by said moisture sensor is below a threshold level.

6. (canceled)

7. The air purifying unit according to claim 2, further including a nutrient container (10) for containing said nutrient, a first tank (6), and a second tank (7), wherein said nutrient container is connected with said first tank for supplying said nutrient from said nutrient container to said first tank, and wherein said nutrient container is connected with said second tank for supplying said nutrient from said nutrient container to said second tank.

8. The air purifying unit according to claim 7, wherein said nutrient container is adapted to supply said nutrient from said nutrient container to said first tank at a pre-determined time interval.

9. The air purifying unit according to claim 7, wherein said first tank is for containing water with which said nutrient from said nutrient container is mixed when supplied from said nutrient container to said first tank.

10. The air purifying unit according to claim 2, further including a moisture sensor (33) for sensing the moisture level in said soil, and wherein said first tank includes at least one pump (12, 13) which is adapted to draw said water mixed with said nutrient from said first tank and to deliver said water mixed with said nutrient directly into said soil when the moisture level in said soil as sensed by said moisture sensor is below a threshold level.

11. (canceled)

12. The air purifying unit according to claim 1, including a controller (11) for controlling the operation of said air purifying unit, wherein said controller is connected with at least one of a PM 2.5 detector (500), a temperature sensor (502), a methanal sensor (503), a carbon dioxide sensor (504), a total volatile organic compounds (VTOCs) sensor (505), a sulfur dioxide sensor (506), a nitrogen dioxide sensor (507), a negative ion sensor (508), a global positioning system (GPS) system component (512) for connection with a GPS system, and a light sensor, for controlling the operation thereof.

13. The air purifying unit according to claim 1, wherein said nutrient includes at least a Bacillus subtilis micro-organism preparation.

14. The air purifying unit according to claim 13, wherein said nutrient further includes at least a substance selected from a group including minerals, composite vitamins, and amino acids.

15. The air purifying unit according to claim 1, wherein said soil includes at least a material selected from a group including stones, porous stones, porous high-temperature calcined soil, porous fossils and shells with creeks and/or gaps.

16. The air purifying unit according to claim 15, wherein said soil has been soaked in water with sugar and/or yeast-type fermenting preparations.

17. The air purifying unit according to claim 16, wherein said soil has been soaked in water with sugar and/or yeast-type fermenting preparations for two weeks to one month.

18. The air purifying unit according to claim 1, wherein the soil container is air permeable and/or includes at least one opening which allows air to pass through.

19. (canceled)

20. An air purifying device (50) including an air purifying unit (52) according to claim 1 and at least one land plant (4) planted in said soil in said soil container.

21. An air purifying assembly (200, 300, 400) including: a plurality of soil containers (101, 101a, 301) containing soil, at least one automatic nutrient delivery system for delivering a nutrient to said soil, and at least one airflow generator (404) for drawing air from outside of said air purifying assembly, through said soil in said plurality of soil containers, and out of said soil in said plurality of soil containers.

22. The air purifying assembly according to claim 21, including a plurality of recesses (202, 402) each for receiving at least one of said plurality of soil containers.

23. The air purifying assembly according to claim 21, further including at least a common air outlet (203, 302, 403, 405) for discharge of said air drawn out of said soil in said plurality of soil containers to the outside environment.
